(19) United States
(12) Patent Application Publication
(10) Pub. No.: US 2010/0015976 A1
(43) Pub. Date: Jan. 21, 2010

(54) SYSTEM AND METHOD FOR SHARING RIGHTS-ENABLED MOBILE PROFILES

(75) Inventors: Alfredo C. Issa, Apex, NC (US); Richard J. Walsh, Raleigh, NC (US); Kenneth Jennings, Durham, NC (US); Hugh Svendsen, Chapel Hill, NC (US)

Correspondence Address: WITHROW & TERRANOVA CT, 100 REGENCY FOREST DRIVE , SUITE 160, CARY, NC, 27518, US

(73) Assignee: DOMINGO ENTERPRISES, LLC, WILMINGTON, DE (US)

(21) Appl. No.: 12/174,935

(22) Filed: Jul. 17, 2008

(51) Int. Cl. H04Q 7/20; G06F 15/16; G06F 21/00; G06F 17/30; H04L 9/00; G06F 7/06

(52) U.S. Cl. 455/435.1; 709/228; 726/3; 713/150; 709/205; 707/5; 707/102; 707/E17.005; 707/E17.017

(57) ABSTRACT

A system and method are provided for sharing rights-enabled user profiles among users in voice communication system, such as a mobile telecommunications system. In general, each user defines a user profile and associated access rights, where the user profile and access rights are stored by or accessible to a profile service. When a voice session, or call, is initiated between a first and second user, a device of the first user requests a profile of the second user from the profile service. In response, the profile service determines whether the first user has been granted access rights to the user profile of the second user. If so, the profile service provides the user profile of the second user, or a portion thereof, to the device of the first user according to the access rights of the first user, and the user profile is presented to the first user.

### RELATED APPLICATION

The present application is related to commonly assigned U.S. patent application Ser. No. ______, filed Jul. 17, 2008, entitled “PROFILE SERVICE FOR SHARING RIGHTS-ENABLED MOBILE PROFILES,” which is hereby incorporated herein in its entirety.

### FIELD OF THE INVENTION

The present invention relates to sharing user profiles.

### BACKGROUND OF THE INVENTION

Mobile telecommunications devices are prolific in today's digital world. One issue with traditional mobile telecommunications devices is that the traditional contacts list and Caller ID features are somewhat unsatisfactory considering the capabilities of these devices. As such, there is a need for an improved system and method that addresses this issue.

### SUMMARY OF THE INVENTION

The present invention relates to sharing of rights-enabled user profiles among users in communication systems, such as a mobile telecommunications system. In general, each user defines a user profile and associated access rights, where the user profile and access rights are stored by or accessible to a profile service. In one embodiment, when a voice session, or call, is initiated between a first and second user, a device of the first user requests a profile of the second user from the profile service. In response, the profile service determines whether the first user has been granted access rights to the user profile of the second user. If so, the profile service provides the user profile of the second user, or a portion thereof, to the device of the first user according to the access rights of the first user. Once received, the user profile of the second user is presented to the first user at the device of the first user. In one embodiment, the user profile of the second user is presented to the first user prior to a time at which the first user must decide whether to accept, or answer, the call. The user profile of the second user may continue to be presented or otherwise accessible to the first user during the call.

The user profile of the second user may also be stored or cached at the device of the first user for subsequent use. In addition, if the second user thereafter updates his or her user profile or the access rights to his or her user profile granted to the first user, the updates may be reflected in the user profile of the second user stored at the user device for the first user or the portion of the user profile of the second user available to the first user at the user device of the first user.

Still further, the user profile of the second user may include information defining a manner in which the first user is to be alerted of the call based on a relationship between the first and second users in a social network. For example, a desired alert may be defined for each of a number of relationship types in the social network. Each of the alerts may be a defined ring type, a defined ring tone, a defined text message, or the like. When the call is initiated by the second user, the device of the first user obtains the user profile of the second user from the profile service, which in this embodiment is part of a social network service such as that provided by a social networking website. In one embodiment, in addition to the user profile of the second user, information identifying the relationship between the first and second users in the social network may be provided to the device of the first user. Then, the desired alert for the relationship type corresponding to the relationship of the first and second users in the social network is selected as the alert to be used to notify the first user of the initiation of the call by the second user. In an alternative embodiment, the user profile of the first user may include the information defining a manner in which the first user is to be alerted of the call based on a relationship between the first and second users in the social network.

Still further, based on, for example, a call log maintained by the device of the first user or the profile service, a determination may be made as to whether to recommend that the first user add the second user as a contact, or a user having a direct relationship with the first user, in the social network; whether to recommend that the second user add the first user as a contact in the social network of the second user; or both. Similarly, a determination may be made as to whether to recommend that the first user remove the second user as a contact in the social network of the first user, that the second user remove the first user as a contact in the social network of the second user, or both.

Lastly, based on the social network, a recommendation may be made to the first user, the second user, or both the first and second users as to other users to add to the call to provide a conference call. More specifically, in order to make recommendations to the first user, a relationship between the first user and the second user in the social network may be determined. Other users in the social network having a similar relationship with the first user are then identified and recommended to the first user for a conference call. In addition or alternatively, the recommendations may be made based on a topic of the conversation between the first and second users and expressed topics of interest for other users in the social network. Likewise, users for a conference call may be recommended to the second user.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system for sharing rights-enabled user profiles according to one embodiment of the present invention;

FIG. 2 illustrates the operation of the system of FIG. 1 according to a first embodiment of the present invention;

FIG. 3 illustrates the operation of the system of FIG. 1 according to a second embodiment of the present invention;

FIG. 4 illustrates an exemplary social network of a recipient;

FIG. 5 illustrates the operation of the system of FIG. 1 according to a third embodiment of the present invention;

FIG. 6 is a flow chart illustrating the operation of the profile service of FIG. 1 to make recommendations as to users to add or remove as contacts of other users according to one embodiment of the present invention;

FIG. 7 illustrates the operation of the system of FIG. 1 according to a fourth embodiment of the present invention;

FIGS. 8A and 8B graphically illustrate the selection of users to recommend for a conference call according to one embodiment of the present invention;

FIG. 9 is a block diagram of one of the mobile devices of FIG. 1 according to one embodiment of the present invention; and

FIG. 10 is a block diagram of a server hosting the profile service of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

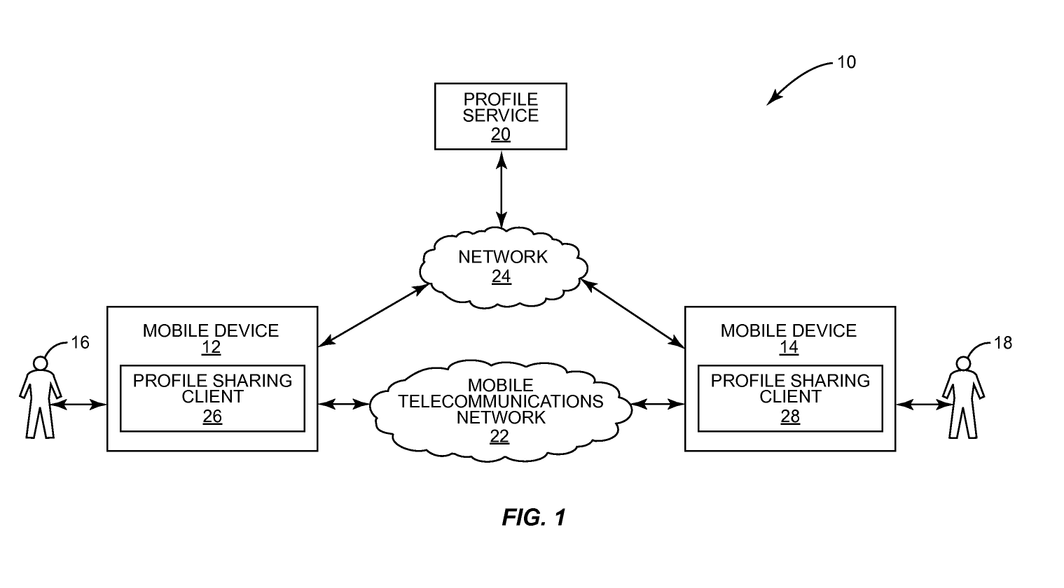

FIG. 1 illustrates a system 10 for sharing rights-enabled profiles among users in association with the initiation of a voice session or during an active voice session according to one embodiment of the present invention. It should be noted that while FIG. 1 and much of the discussion herein focuses on an embodiment of the present invention implemented in a mobile telecommunications network, the present invention is not limited thereto. The present invention is equally applicable to other types of systems for establishing voice sessions between users such as, for example, a Voice Over Internet Protocol (VOIP) system such as that utilized by VOIP services such as the Skype® VOIP service. Still further, while the discussion herein focuses on voice communication, the present invention is not limited thereto. The present invention is equally applicable to other types of communication sessions such as, for example, text-based communication sessions or video-based communication sessions.

In general, the system 10 includes mobile telecommunications devices 12 and 14, which are hereinafter referred to as mobile devices 12 and 14, having associated users 16 and 18. In addition, in this embodiment, the system 10 includes a profile service 20. As discussed below, the mobile devices 12 and 14 enable the users 16 and 18 to initiate and establish a voice session via a mobile telecommunications network 22. The mobile telecommunications network 22 may be, for example, a Global System for Mobile communications (GSM) network, an Enhanced Data rates for GSM Evolution (EDGE) network, a Code Division Multiple Access (CDMA) network, a Wideband CDMA (W-CDMA) network, or the like. In addition, the mobile devices 12 and 14 may communicate with one another and the profile service 20 via a network 24. The network 24 may be a Wide Area Network (WAN) such as, for example, the Internet. Note that while the mobile telecommunications network 22 and the network 24 are illustrated separately for clarity, one of ordinary skill in the art will appreciate that the mobile devices 12 and 14 may have access to the network 24 via the mobile telecommunications network 22, via a local wireless interface such as a Bluetooth® or IEEE 802.11x interface, or the like.

The mobile devices 12 and 14 are generally mobile telecommunication devices such as mobile smart phones or the like. For example, the mobile devices 12 and 14 each may be, or be similar to, an Apple® iPhone. The mobile device 12 includes a profile sharing client 26, which may be implemented in software, hardware, or a combination thereof. The profile sharing client 26 may be a pre-loaded component of the mobile device 12, a downloadable software application that has been downloaded to and installed on the mobile device 12, or the like. In operation, when a call between the users 16 and 18 is initiated by the user 18, the profile sharing client 26 generally operates to obtain a user profile of the user 18 from the profile service 20 and present the user profile of the user 18 to the user 16 at the mobile device 12. More specifically, the user profile of the user 18 may be requested automatically in response to initiation of the call. Alternatively, the user profile of the user 18 may be requested automatically in response to establishment of the call. As yet another alternative, the user profile of the user 18 may be requested during the call in response to, for example, a request from the user 16. Additional or alternative functions that may be performed by the profile sharing client 26 are discussed below. In a similar manner, the mobile device 14 includes a profile sharing client 28.

The profile service 20 may be hosted by a server or a group of servers operating in a collaborative fashion. In one embodiment, as discussed below, the profile service 20 is part of a social networking service or has access to one or more social networking services. A social networking service may be, for example, a social networking website such as, for example, the MySpace® social networking website, the Facebook® social networking website, the LinkedIN® social networking website, or the like.

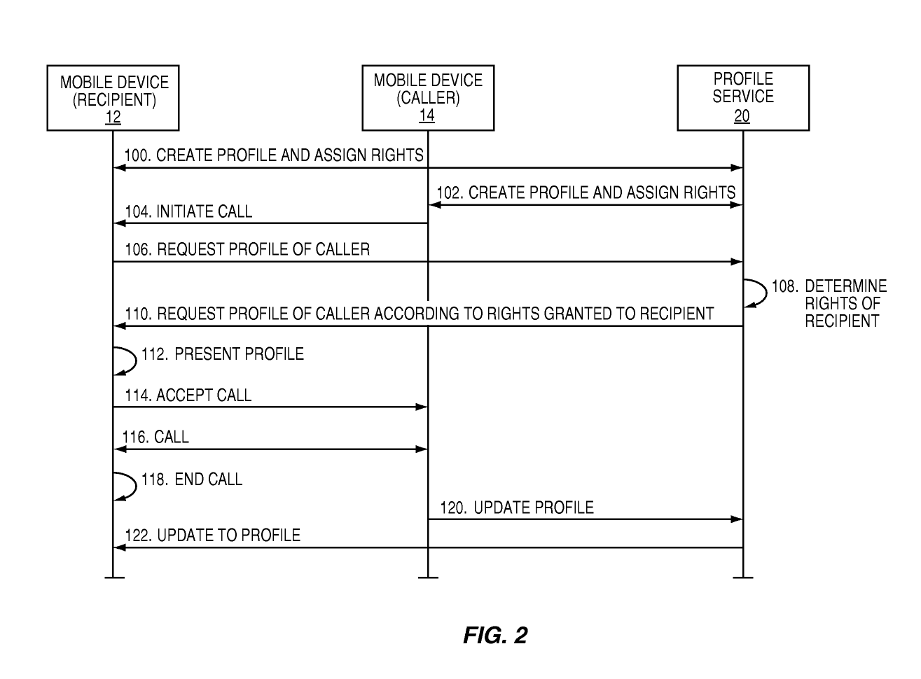

FIG. 2 illustrates the operation of the system 10 of FIG. 1 according to one embodiment of the present invention. First, the users 16 and 18 interact with the profile service 20 via the mobile devices 12 and 14 to create user profiles and assign access rights to their user profiles (steps 100 and 102). Note, however, that steps 100 and 102 are exemplary. The present invention is not limited thereto. For example, in one embodiment, the profile service 20 is part of or enabled to access a social networking service in order to obtain user profiles. As such, the users 16 and 18 may interact with the social networking service via the mobile devices 12 and 14, via associated user devices such as personal computers, or both their mobile devices 12 and 14 and their associated user devices in order to define their user profiles and assign access rights to their user profiles.

The user profiles of the users 16 and 18 may include various types of information regarding the users 16 and 18. For example, in one embodiment, the user profile of the user 16 may include contact information for the user 16 such as a mobile telephone number of the user 16, a home phone number of the user 16, a work phone number of the user 16, one or more email addresses for the user 16, one or more instant messaging usernames or identifiers (IDs) of the user 16, a home mailing address of the user 16, a work mailing address of the user 16, or the like. The user profile of the user 16 may additionally or alternatively include a picture of the user 16, demographic information describing the user 16, hobbies and interests of the user 16, or the like. The user profile of the user 16 may additionally or alternatively include information identifying media items, such as songs or videos, recently played by the user 16; information identifying websites recently visited by the user 16; locations recently visited by the user 16; or the like. Still further, the user profile of the user 16 may additionally or alternatively include one or more media items recommended by the user 16 such as, for example, a number of songs identified by the user 16 as favorites of the user 16; one or more websites recommended by the user 16 such as, for example, a number of websites identified by the user 16 as favorites of the user 16; or the like. The profile of the user 16 may additionally or alternatively include a list of contacts of the user 16. Note that, as used herein, a “contact” is another user having a direct relationship with the user 16 via a social network; a contact list such as, for example, a contact list maintained by the mobile device 12, a contact list maintained by an email application, or a contact list maintained by an instant messaging application; or the like. The user profile of the user 16 may also include a custom ring tone of the user 16 which is to be used to alert other users when the user 16 has initiated a call with them. As a final example, the profile of the user 16 may additionally or alternatively include one or more media items such as songs, videos, pictures, or the like, or references thereto, shared by the user 16. For example, the profile of the user 16 may include a slideshow, or a reference such as a Uniform Resource Locator (URL) to the slideshow, shared by the user 16.

Again using the user 16 as an example, the access rights generally include one or more user-based rules or group-based rules defining whether the corresponding users or groups of users are granted access to the user profile of user 16. The rules may allow access to the full user profile of the user 16, deny access to the full user profile of the user 16, or allow access to a defined portion of the user profile of the user 16 for each user or group of users. The groups of users may be defined based on various criteria such as degree of relationship between the users and the user 16 in a social network, classifier used to describe the relationship between the users and the user 16, or the like. Note that the user 16 may classify his or her contacts in the social network as well as other users in his or her social network using classifiers such as, for example, “friends,” “family,” “co-workers,” or the like. As an example, the user 16 may define the access rights such that contacts of the user 16 in the social network of the user 16 that are classified as friends have access to the full user profile of the user 16, contacts of the user 16 in the social network of the user 16 that are not classified as friends have access to everything in the user profile of the user 16 other than the list of the friends of the user 16, users indirectly related to the user 16 in the social network of the user 16 by two degrees of separation (i.e., two hops between them and the user 16 in the social network) have access to the full contact information of the user 16, all other users indirectly related to the user 16 via the social network of the user 16 have access to limited contact information of the user 16 such as, for example, the email address of the user 16, and all other users are denied access to the user profile of the user 16.

After the user profiles are created and the access rights defined, in this example, the user 18 of the mobile device 14 initiates a call with the user 16 of the mobile device 12 (step 104). Note that, in this example, the user 16 is also referred to as the recipient 16, and the user 18 is also referred to as the caller 18. It should also be noted that while the discussion herein focuses on providing the user profile of the caller 18 to the recipient 16, the present invention is not limited thereto. For example, the user profile of the recipient 16 may additionally or alternatively be provided to the caller 18.

The caller 18 may initiate the call by, for example, dialing the mobile telephone number of the mobile device 12 or initiating automatic dialing of the mobile telephone number of the mobile device 12 by selecting the recipient 16 from a contact list maintained by the mobile device 14, issuing a voice command, or the like. In response, the mobile device 12, and more specifically the profile sharing client 26, requests the user profile of the caller 18 from the profile service 20 (step 106). More specifically, in one embodiment, when the call is initiated, the mobile telephone number of the caller 18 is passed to the mobile device 12. The profile sharing client 26 then utilizes the mobile telephone number of the caller 18 to automatically query the profile service 20 for the user profile of the user 18. In addition or alternatively, information such as a name of the user 18 provided by a traditional Caller ID service may be used to query the profile service 20. Note that, in one embodiment, an alert, such as a mobile telephone ring, used to notify the recipient 16 of the call may be delayed until the user profile of the caller 18 has been requested and obtained from the profile service 20.

Note that while the discussion herein focuses on automatically requesting the user profile of the caller 18 from the profile service 20 in response to initiation of the call, the present invention is not limited thereto. For example, the user profile of the caller 18 may alternatively be requested after the call is initiated with the recipient 16 but before the call has been answered, automatically requested after the call has been established as a result of the recipient 16 accepting, or answering, the call, or requested during the call such as, for example, at the request of the recipient 16.

In response to the request, the profile service 20 identifies the user profile of the caller 18 and determines the access rights to the user profile of the caller 18 granted to the recipient 16 (step 108). For example, if the access rights for the user profile of the caller 18 are defined by user-based rules, the profile service 20 may determine the access rights by first determining whether a user-based rule has been defined for the recipient 16. If so, the user-based rule(s) for the recipient 16 are selected as those defining the access rights for the recipient 16. Otherwise, the recipient 16 may be denied access to the user profile of the caller 18. Alternatively, one or more default rules may define default access rights for all users not specifically covered by the user-based rules. As another example, if the access rights for the user profile of the caller 18 are defined by group-based rules, the profile service 20 may first identify the group to which the recipient 16 belongs. Then, the group-based rule(s) for the identified group are selected as those defining the access rights for the recipient 16. In an alternative embodiment, the access rights may be manually set after the call has been established. For example, after the call has been established, the caller 18 may manually set the access rights for the recipient 16.

Once the access rights of the recipient 16 are determined, the profile service 20 provides the user profile of the caller 18 to the mobile device 12 of the recipient 16 according to the access rights of the recipient 16 (step 110). In one embodiment, the user profile of the caller 18 is filtered according to the access rights granted to the recipient 16 to remove content from the user profile to which the recipient 16 has not been granted access, and the filtered user profile is provided to the mobile device 12 of the recipient 16. In another embodiment, the user profile of the caller 18 is protected using a Digital Rights Management (DRM) technique such as encryption. A license may then be generated and sent to the mobile device 12 to allow access to the content in the user profile to which the recipient 16 has been granted access rights and deny access to the content in the user profile to which the recipient 16 has not been granted access rights.

Upon receiving the user profile of the caller 18, the mobile device 12, and more specifically the profile sharing client 26, presents the user profile of the caller 18 to the recipient 16 (step 112). Note that, as discussed above, in one embodiment the user profile received by the mobile device 12 and presented to the recipient 16 is a filtered version of the full user profile of the caller 18. In another embodiment, the user profile of the caller 18 is protected using a DRM technique, and the user profile of the caller 18 is presented to the recipient 16 according to the access rights granted to the recipient 16, which may be represented by a license enabling access to the appropriate content in the user profile of the caller 18. In one embodiment, the user profile of the caller 18 is obtained from the profile service 20 before the recipient 16 is alerted of the call. As such, the user profile of the caller 18 may be presented to the recipient 16 while the recipient 16 is alerted of the call by, for example, ringing, a ringtone, vibration, or the like. Note that the user profile of the caller 18 may continue to be presented to the recipient 16 during the call or otherwise be accessible to the recipient 16 during the call. Still further, the user profile 16 is preferably stored at the mobile device 12 for subsequent use.

In this example, the recipient 16 accepts the call (step 114), and the call is established (step 116). Note that the user profile of the caller 18 may continue to be presented to the recipient 16 during the call and optionally be stored and accessible to the recipient 16 after the call has ended. In an alternative embodiment, the profile sharing client 26 may request, obtain, and present the user profile of the caller 18 after the call has been established. In yet another alternative embodiment, the profile sharing client 26 may request the user profile of the caller 18 upon the call being initiated in step 104. The profile sharing client 26 may then present the user profile of the caller 18 to the recipient 16 upon receiving the user profile from the profile service 20. Depending on when the user profile of the caller 18 is received, the user profile of the caller 18 may be presented to the recipient 16 before or after the recipient 16 has accepted the call and the call has been established. Note that if the recipient 16 were to choose not to accept the call, the access rights granted to the recipient 16 may be revoked at that time. Alternatively, the access rights granted to the recipient 16 may thereafter be limited or edited by the caller 18.

In this example, at some point during the call, the recipient 16 chooses to end the call (step 118). At some point thereafter, the user 18 updates his or her user profile, the access rights to his or her user profile, or both (step 120). In response, assuming that the user profile of the user 18 has been stored or cached at the mobile device 12, the profile service 20 updates the copy of the user profile of the user 18 stored at the mobile device 12 to reflect the changes made to the user profile and/or the access rights granted to the user 16 for the user profile (step 122). For example, if the user 18 updates his or her contact information, the updated contact information may be provided to the mobile device 12 and used to update the copy of the user profile of the user 18 stored at the mobile device 12. As another example, if the user 18 has updated the access rights granted to the user 16 to allow access to a greater amount of the user profile of the user 18, the profile service 20 may provide the additional information to the mobile device 12 or grant a new license to the user profile depending on the particular implementation. As a final example, if the user 18 has updated the access rights granted to the user 16 to deny access to content in the user profile to which the user 16 was previously granted access, the profile service 20 may provide a new copy of the user profile to the mobile device 12 where the mobile device replaces the stored copy of the user profile with the new copy of the user profile, request that the copy of the user profile stored at the mobile device 12 be updated to remove the content to which the user 16 has been denied access, or the like. Alternatively, if a DRM technique is used, the profile service 20 may generate and send a new license to the mobile device 12 in order reflect the updated access rights of the user 16.

In one embodiment, the copy of the user profile of the user 18 stored at the mobile device 12 of the user 18 may be updated the next time that the user 18 initiates a call with the user 16, the next time the user 16 initiates a call with the user 18, or either the next time that the user 16 calls the user 18 or the next time that the user 18 calls the user 16. In another embodiment, the profile service 20 may update the copy of the user profile of the user 18 stored at the mobile device 12 of the user 16 in an asynchronous manner. As an example, the in response to receiving the update from the user 18, the profile service 20 may identify other users such as the user 16 or mobile devices of other users such as the mobile device 12 to which the user profile of the user 18 has been provided. The profile service 20 may then update the copies of the user profile of the user 18 stored at the mobile devices of the identified users or the identified mobile devices depending on the implementation. Alternatively, the mobile devices may periodically request updates from the profile service 20.

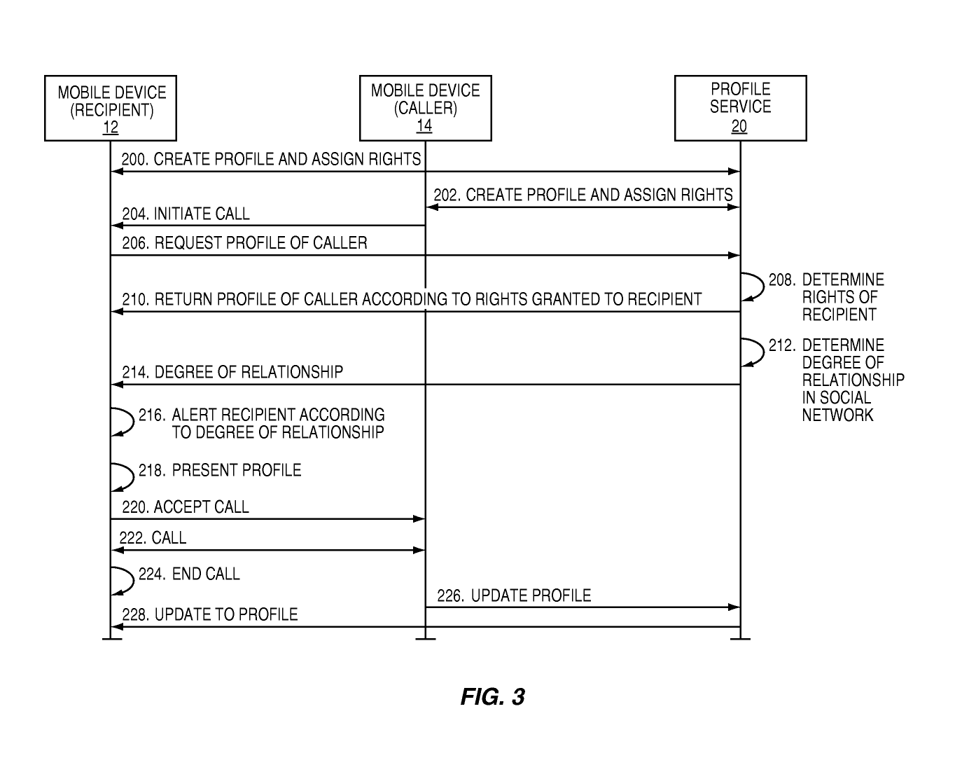

FIG. 3 illustrates the operation of the system 10 of FIG. 1 according to a second embodiment of the present invention that is substantially the same as that discussed above with respect to FIG. 2. However, in this embodiment, an alert provided to the recipient 16 is selected based on a relationship between the recipient 16 and the caller 18 in a social network. More specifically, as discussed above with respect to FIG. 2, the users 16 and 18 create user profiles and assign access rights to their user profiles (steps 200 and 202). After the user profiles are created and the access rights defined, in this example, the user 18 of the mobile device 14 initiates a call with the user 16 of the mobile device 12 (step 204). Again, in this example, the user 16 is also referred to as the recipient 16, and the user 18 is also referred to as the caller 18.

In response, the mobile device 12, and more specifically the profile sharing client 26, requests the user profile of the caller 18 from the profile service 20 (step 206). In response to the request, the profile service 20 identifies the user profile of the caller 18 and determines the access rights to the user profile of the caller 18 granted to the user 16 (step 208). Once the access rights of the recipient 16 are determined, the profile service 20 provides the user profile of the caller 18 to the mobile device 12 of the recipient 16 according to the access rights of the recipient 16 (step 210).

In this example, in addition to returning the user profile of the caller 18 to the mobile device 12 of the recipient 16, the profile service 20 also determines a relationship between the recipient 16 and the caller 18 in a social network (step 212). More specifically, in this embodiment, the profile service 20 determines a degree of relationship between the recipient 16 and the caller 18 in the social network of the recipient 16. However, the present invention is not limited thereto. The relationship may additionally or alternatively be described by a classifier or tag such as “friends,” “family,” “co-workers,” or the like.

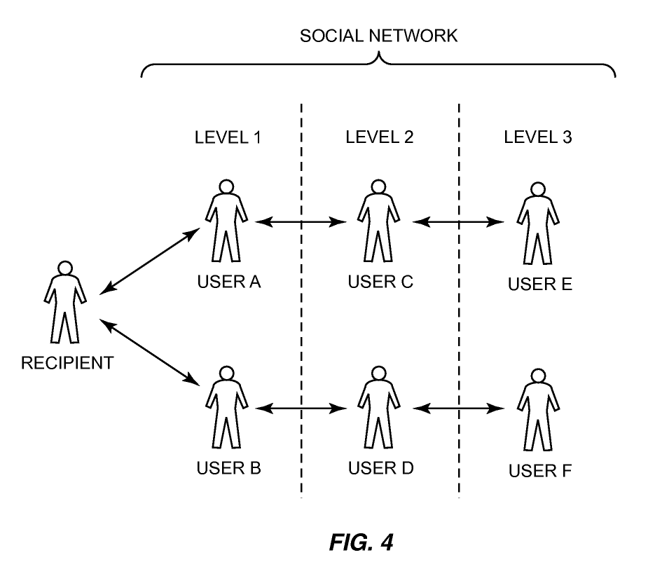

Referring briefly to FIG. 4, an exemplary social network of the recipient 16 is illustrated. The social network includes users A and B, which have a direct relationship with the recipient 16 and are referred to herein as contacts of the recipient 16. There is one (1) degree of separation between the recipient 16 and each of the users A and B. In other words, there is only one (1) hop between the recipient 16 and each of the users A and B in the social network. In contrast, users C and D are not directly related to the recipient 16. Rather, the user C is indirectly related to the recipient 16 via the user A and is therefore said to be related to the recipient 16 by two (2) degrees of separation. Similarly, the user D is indirectly related to the recipient 16 via the user B and is therefore said to be related to the recipient 16 by two (2) degrees of separation. The users E and F are also indirectly related to the recipient 16. More specifically, the user E is indirectly related to the recipient 16 via the users A and C and is therefore said to be related to the recipient 16 by three (3) degrees of separation. Likewise, the user F is indirectly related to the recipient 16 via the users B and D and is therefore said to be related to the recipient 16 by three (3) degrees of separation.

Returning to FIG. 3, in one embodiment, the profile service 20 is part of a social networking service. As such, the profile service 20 determines a degree of separation between the recipient 16 and the caller 18 in the social network of the recipient 16 maintained by the social networking service. Alternatively, the profile service 20 may request the degree of separation between the recipient 16 and the caller 18 from a social networking service. Once the degree of separation between the recipient 16 and the caller 18 is determined, information defining the degree of relationship is provided to the mobile device 12 of the recipient 16 from the profile service 20 (step 214). The information defining the degree of relationship may include a numerical value defining the degree of relationship, a diagram indicating the relationship between the recipient 16 and the caller 18 in the social network, or the like. Again, note that in addition to or as an alternative to degree of separation, other information identifying the relationship between the recipient 16 and the caller 18 may be used such as, for example, a classifier describing the relationship between the recipient 16 and the caller 18.

It should be noted that, in an alternative embodiment, the mobile device 12 of the recipient 16 may already store information defining the social network of the recipient 16. For example, the mobile device 12 may have previously requested the information defining the social network of the recipient 16 from the profile service 20 or an associated social networking service. The relationship between the recipient 16 and the caller 18 may therefore alternatively be determined by the mobile device 12 of the recipient 16.

At this point, the mobile device 12 presents an alert to the recipient 16 notifying the recipient 16 of the call initiated by the caller 18, where the alert is selected according to the degree of relationship between the recipient 16 and the caller 18 (step 216). More specifically, in one embodiment, the user profile of the caller 18 defines a desired alert to be used when the caller 18 calls another user based on a degree of separation between the caller 18 and the other user in the social network. The caller 18 may define a desired alert for each of one or more degrees of separation, for each of one or more ranges of degrees of separation, or both. Note that the desired alerts may vary depending on time of day. For each degree of separation or range of degrees of separation, the desired alert may be defined as a desired ring type such as ring, vibrate, ring and vibrate, or the like; a desired ring tone; a desired text message to be provided instead of a ring type or ring tone or in addition to a defined ring type or ring tone; or the like. As such, the mobile device 12 uses the degree of separation between the recipient 16 and the caller 18 to select the desired alert to present to the recipient 16 according to the user profile of the caller 18, and then presents the desired alert to the recipient 16.

In another embodiment, the user profile of the recipient 16 may be stored at the mobile device 12 or additionally obtained from the profile service 20, where the user profile of the recipient 16 defines a desired alert to be presented to the recipient 16 based on a relationship between the recipient 16 and the user calling the recipient. More specifically, according to this example, the user profile of the recipient 16 may define a desired alert for each of a number of degrees of separation and/or ranges of degrees of separation. Then, based on the degree of separation between the recipient 16 and the caller 18, the mobile device 12 selects a desired alert to be presented to the recipient 16 according to the user profile of the recipient 16. In yet another embodiment, the desired alert to be presented to the recipient 16 may be selected based on the user profiles of the recipient 16 and the caller 18.

In this example, while the alert is being presented to the recipient 16, the profile sharing client 26 of the mobile device 12 also presents the user profile of the caller 18 to the recipient 16 (step 218). Note that, as discussed above, in one embodiment the user profile received by the mobile device 12 and presented to the recipient 16 is a filtered version of the full user profile of the caller 18. In another embodiment, the user profile of the caller 18 is protected using a DRM technique, and the user profile of the caller 18 is presented to the recipient 16 according to the access rights granted to the recipient 16, which may be represented by a license enabling access to the appropriate content in the user profile of the caller 18. Note that the user profile of the caller 18 may continue to be presented to the recipient 16 during the call or otherwise be accessible to the recipient 16 during the call. Still further, the user profile of the caller 18 is preferably stored at the mobile device 12 for subsequent use.

In this example, the recipient 16 accepts the call (step 220), and the call is established (step 222). Note that, as discussed above, the user profile of the caller 18 may continue to be presented to the recipient 16 during the call and optionally be stored and accessible to the recipient 16 after the call has ended. In an alternative embodiment, the profile sharing client 26 may request, obtain, and present the user profile of the caller 18 after the call has been established. In yet another alternative embodiment, the profile sharing client 26 may request the user profile of the caller 18 upon the call being initiated in step 204. The profile sharing client 26 may then present the user profile of the caller 18 to the recipient 16 upon receiving the user profile from the profile service 20. Depending on when the user profile of the caller 18 is received, the user profile of the caller 18 may be presented to the recipient 16 before or after the recipient 16 has accepted the call and the call has been established.

In this example, at some point during the call, the recipient 16 chooses to end the call (step 224). At some point thereafter, the user 18 updates his or her user profile, the access rights to his or her user profile, or both (step 226). In response, assuming that the user profile of the user 18 has been stored or cached at the mobile device 12, the profile service 20 updates the copy of the user profile of the user 18 stored at the mobile device 16 to reflect the changes made to the user profile and/or the access rights granted to the user 16 for the user profile (step 228).

It should be noted that the selection of the alert used to notify the recipient 16 of the call from the caller 18 based on the relationship of the recipient 16 and the caller 18 as discussed above may be used with or without the sharing and presentation of the user profile of the caller 18 to the recipient 16. For example, the user profile of the caller 18 may include only the information defining the desired alert to be used for each of a number of relationship types (e.g., degrees of separation, ranges of degrees of separation, relationship classifiers, or combinations thereof). The user profile of the caller 18 may then be used to select the desired alert to be used to notify the recipient 16 of the call. As another example, if the desired alert is to be selected based on the user profile of the recipient 16, then the user profile of the caller 18 may not need to be obtained from the profile service 20.

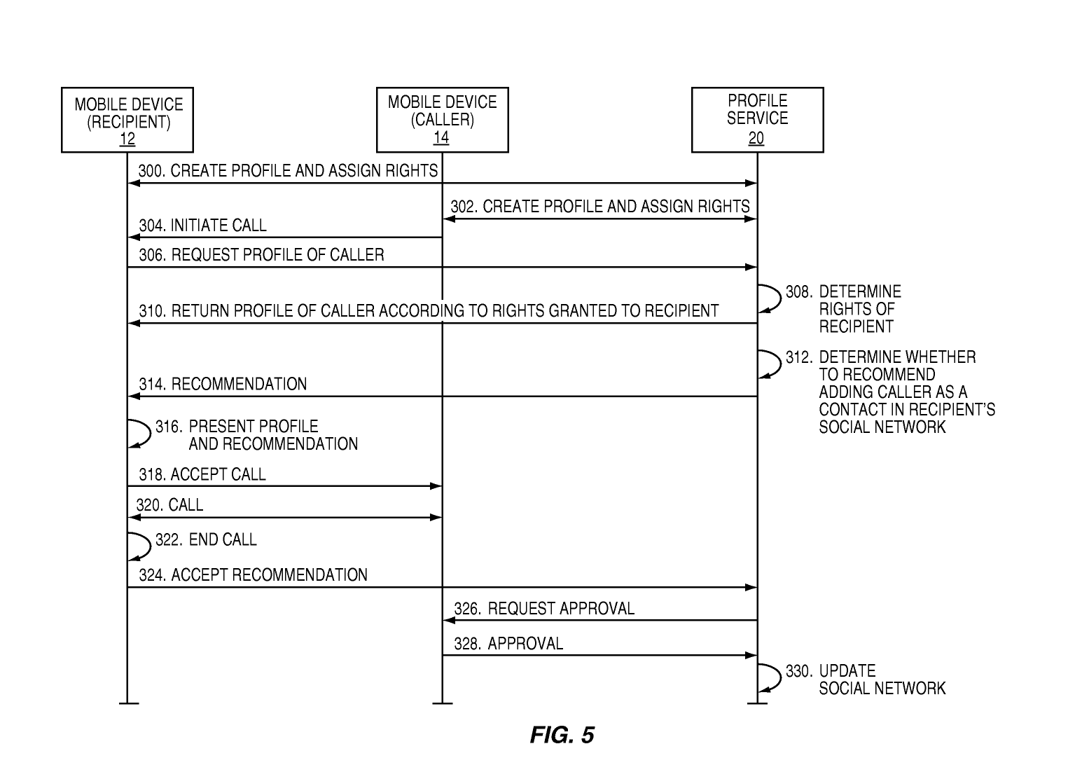

FIG. 5 illustrates the operation of the system 10 of FIG. 1 according to a third embodiment of the present invention that is substantially the same as that discussed above with respect to FIG. 2. However, in this embodiment, the profile service 20 also operates to determine whether to recommend that the recipient 16 add the caller 18 as a contact in the social network of the recipient 16. In addition or alternatively, the profile service 20 may recommend one or more additional social network services or activities such as, for example, signing a guest book of a social networking website of the caller 18. More specifically, as discussed above with respect to FIG. 2, the users 16 and 18 create user profiles and assign access rights to their user profiles (steps 300 and 302). After the user profiles are created and the access rights defined, in this example, the user 18 of the mobile device 14 initiates a call with the user 16 of the mobile device 12 (step 304). Again, in this example, the user 16 is also referred to as the recipient 16, and the user 18 is also referred to as the caller 18.

In response, the mobile device 12, and more specifically the profile sharing client 26, requests the user profile of the caller 18 from the profile service 20 (step 306). In response to the request, the profile service 20 identifies the user profile of the caller 18 and determines the access rights granted to the recipient 16 for the user profile of the caller 18 (step 308). Once the access rights of the recipient 16 are determined, the profile service 20 provides the user profile of the caller 18 to the mobile device 12 of the recipient 16 according to the access rights of the recipient 16 (step 310).

In this example, in addition to returning the user profile of the caller 18 to the mobile device 12 of the recipient 16, the profile service 20 also determines whether to recommend that the recipient 16 add the caller 18 as a contact in the social network of the recipient 16 (step 312). More specifically, in one embodiment, the profile service 20 maintains a call log indicating a number of times that the caller 18 has called the recipient 16, a number of times that the recipient 16 has called the caller 18, or both. In addition, the call log may include a time stamp for each of the calls. Note that the call log may be maintained by the profile service 20 by recording the requests for user profiles received from the mobile devices 12 and 14 in response to call initiation. Then, based on one or more rules and the call log, the profile service 20 determines whether to recommend that the recipient 16 add the caller 18 as a contact in the social network of the recipient 16. The rules may be system-defined rules or user-defined rules defined by the recipient. For example, the rules may state that if another user calls the recipient 16 three (3) or more times in one day and if that user is not already a contact in the social network of the recipient 16, then the profile service 20 is to recommend that the recipient 16 add that user as a contact.

In another embodiment, in addition or as an alternative to using the call log, the profile service 20 may determine whether to recommend that the recipient 16 add the caller 18 as a contact in the social network of the recipient based on social network activity. For example, if the caller 18 has posted comments on a social networking webpage of the recipient 16 three (3) or more times over the course of a week and the caller 18 is not already in the social network of the recipient 16, then the profile service 20 may recommend that the recipient 16 add the caller 18 as a contact. In this case, the recommendation may include an alert that the caller 18 has posted comments on the social networking webpage of the recipient 16 and/or the comments, or recent comments, posted by the recipient 16. As another example, the profile service 20 may consider indirect social network activity such as a friend or contact of the caller 18 posting comments on the social networking webpage of the recipient 16.

In yet another embodiment, in addition or as an alternative to using the call log, the profile service 20 may consider static criteria such as, for example, a number of hops, or the degrees of separation, between the caller 18 and the recipient 16 in the social network of the caller 18 and/or recipient. For example, a user-defined or system-defined rule may provide that if there are three or less degrees of separation between the caller 18 and the recipient 16 in the social network and the recipient 16 is not already a contact of the caller 18 in the social network, then the profile service 20 is to recommend that the recipient 16 add the caller 18 as a contact.

Note that the profile service 20 may additionally or alternatively determine whether to recommend removing the caller 18 from the social network of the recipient 16. More specifically, the call log maintained by the profile service 20 may also include, for each call, an indication as to whether the call was answered. An indicator that a call was answered or an indicator that a call was not answered may be provided to the profile service 20 from the corresponding mobile device of the recipient of the call. Thus, for example, a rule may state that if the recipient 16 has not answered the last X calls from the caller 18 and the caller 18 is in the social network of the recipient 16, then a recommendation is to be made to remove the caller 18 from the social network of the recipient 16. As another example, a rule may state that if the recipient 16 has not answered the last Y calls from the caller 18, the recipient 16 has not retuned at least one (1) of those calls, and the caller 18 is in the social network of the recipient 16, then a recommendation is to be made to remove the caller 18 from the social network of the recipient 16.

In an alternative embodiment, the profile sharing client 26 of the mobile device 12 may determine whether to recommend adding the caller 18 to the social network of the recipient 16 and/or whether to recommend removing the caller 18 from the social network of the recipient 16 based on a call log maintained at the mobile device 12 of the recipient 16. Note that in order to determine whether the caller 18 is or is not already a contact in the social network of the recipient 16, the mobile device 12 may store information identifying the contacts in the social network of the recipient 16, which may have been previously requested from the profile service 20 or an associated social networking service. Alternatively, the profile service 20 may notify the mobile device 12 of whether the caller 18 is a contact in the social network of the recipient 16 when providing the user profile in step 310 or upon request.

In this example, the profile service 20 has determined that a recommendation is to be provided to the recipient 16 to recommend adding the caller 18 as a contact in the social network of the recipient 16. As such, the profile service 20 sends the recommendation to the mobile device 12 of the recipient 16 (step 314). At this point, the profile sharing client 26 presents the user profile of the caller 18 and the recommendation to the recipient 16 at the mobile device 12 (step 316). In an alternative embodiment, the user profile of the caller 18 may be presented to the recipient 16 prior to receiving the recommendation from the profile service 20. In this example, the recipient 16 then accepts, or answers, the call (step 318), and the call is established (step 320). At some time during the call, the recipient 16 chooses to end the call and, as such, the call is ended (step 322).

In this example, sometime after the call has ended, the recipient 16 accepts the recommendation to add the caller 18 as a contact in his or her social network, and, in response, a recommendation acceptance message is sent from the mobile device 12 to the profile service 20 (step 324). Alternatively, the recipient 16 may accept the recommendation to add the caller 18 as a contact either before the call is accepted or during the call. At this point, a request for approval to be added to the social network of the recipient 16 may be provided to the caller 18 at the mobile device 14 (step 326). In this example, the caller 18 approves being added as a contact of the recipient 16, and, in response, an approval message is provided to the profile service 20 (step 328). The profile service 20 then updates the social network by adding the caller 18 as a contact of the recipient 16 in the social network of the recipient 16 (step 330).

In an alternative embodiment, the user profile of the caller 18 may define rights as to who may request that the caller 18 be added as a contact. For example, the caller 18 may define a rule stating that anyone that has not answered his last five (5) calls cannot request to add him as a contact. As such, these rights may be checked before recommending that the recipient 16 add the caller 18 as a contact. If the rights do not permit the recipient 16 to add the caller 18 as a contact, then the recommendation to add the caller 18 as a contact will not be made to the recipient 16. Alternatively, these rights may be checked upon receiving a recommendation acceptance from the recipient 16 requesting to add the caller 18 as a contact. If the recipient 16 is not permitted to add the caller 18 as a contact, then the request to add the caller 18 as a contact is denied. If the recipient 16 is permitted to request to add the caller 18 as a contact, then the caller 18 may automatically be added as a contact of the recipient 16 or approval to be added as a contact of the recipient 16 may be requested from the caller 18.

In another alternative embodiment, if the profile service 20 is not part of the social networking service, the recommendation acceptance message may alternatively be provided directly to the social networking service as a request to add the caller 18 as a contact of the recipient 16 in the social network of the recipient 16. The social networking service may then request approval from the caller 18 by sending a message to the mobile device 14 of the caller 18 or by using a typical approval scheme used by the social networking service. For example, if the social networking service is a social networking website, the caller 18 may be notified of the request to be added as a contact of the recipient 16 the next time that the caller 18 logs into the social networking website. The caller 18 may then choose to approve being added as a contact of the recipient 16 if desired.

It should be noted that even though the discussion above focuses on providing a recommendation to add the caller 18 to or remove the caller 18 from the social network of the recipient 16, the present invention is not limited thereto. In addition or alternatively, a recommendation may be provided to the caller 18 to add the recipient 16 to or remove the recipient 16 from the social network of the caller 18. For example, if the recipient 16 does not answer the call and if the recipient has not answered the last Z calls from the caller 18, a recommendation may be made to remove the recipient 16 as a contact in the social network of the caller 18. It should also be noted that the recommendation process discussed above with respect to FIG. 5 may also be used without sharing the user profile of the caller 18 with the recipient 16 or vice versa.

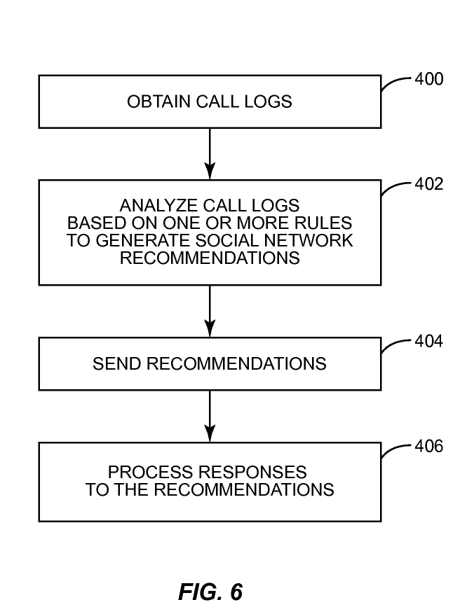

FIG. 6 illustrates a process that may be performed by the profile service 20 to asynchronously determine whether to recommend adding or removing contacts in the social network according to one embodiment of the present invention. This process may be performed as an alternative to the recommendation process discussed above with respect to FIG. 5. First, the profile service 20 obtains call logs for each of the mobile devices 12 and 14 (step 400). Note that while only the mobile devices 12 and 14 are discussed herein for clarity, it should be appreciated that the system 10 may include any number of mobile devices and users. The calls logs may be obtained using any desired technique. For example, in one embodiment, the profile service 20 maintains the call logs using requests for user profiles received from the mobile devices 12 and 14 in response to call initiation. As another example, the profile service 20 may periodically request the call logs, or updates thereto, from the mobile devices 12 and 14. As a final example, the mobile devices 12 and 14 may periodically push the call logs, or updates thereto, to the profile service 20.

Next, the profile service 20 analyzes the call logs based on one or more rules to generate social network recommendations (step 402). In much the same manner as discussed above, using one or more system-defined or user-defined rules, the profile service 20 analyzes the call logs to generate recommendations to add users as contacts of other users in the social network and/or remove users as contacts of other users in the social network. Using the user 16 as an example, the profile service 20 analyzes the call log of the user 16 to identify other users to recommend adding as contacts of the user 16 in the social network of the user 16 and/or other users to recommend removing as contacts of the user 16 in the social network of the user 16.

Once the recommendations are generated, the profile service sends the recommendations to the mobile devices 12 and 14 (step 404). The users 16 and 18 may then choose to accept the recommendations if desired. If the recommendations are accepted, responses are provided to the profile service 20 and processed (step 406). As discussed above, if, for example, the user 16 accepts a recommendation to add the user 18 as a contact, the profile service 20 may first seek approval from the user 18. If approval is received, then the profile service 20 updates the social network of the user 16 accordingly. Likewise, if the user 16 accepts a recommendation to remove the user 18 as a contact, the profile service 20 may update the social network of the user 16 to remove the user 18 as a contact.

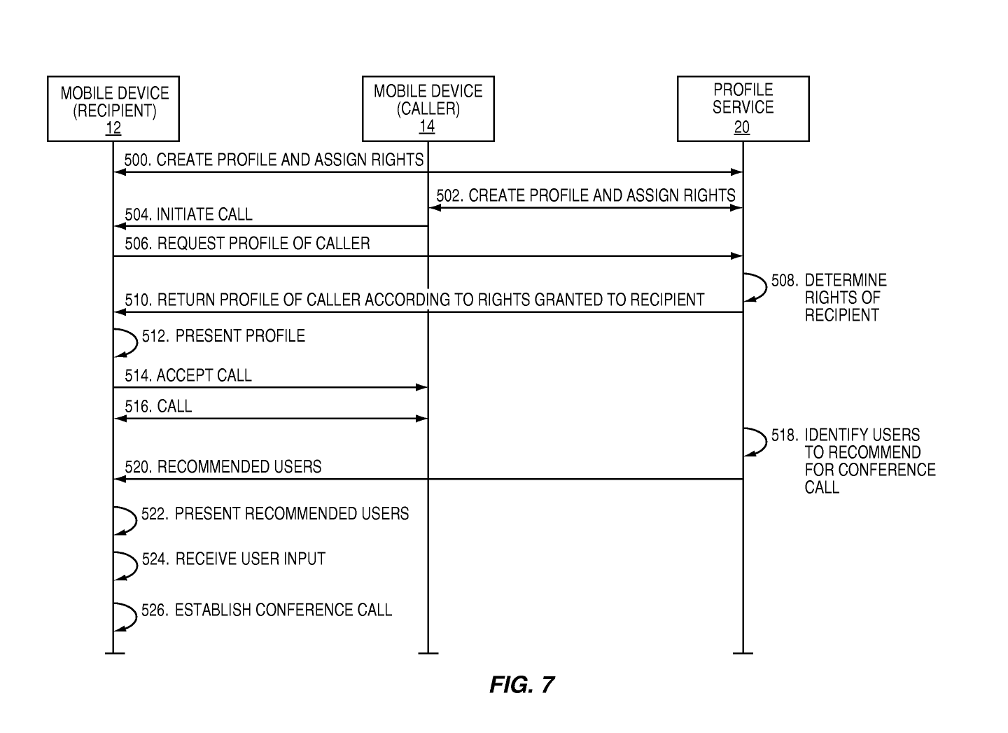

FIG. 7 illustrates the operation of the system 10 of FIG. 1 according to a fourth embodiment of the present invention that is substantially the same as that discussed above with respect to FIG. 2. However, in this embodiment, the profile service 20 also operates to recommend other users for a conference call. More specifically, as discussed above with respect to FIG. 2, the users 16 and 18 create user profiles and assign access rights to their user profiles (steps 500 and 502). After the user profiles are created and the access rights defined, in this example, the user 18 of the mobile device 14 initiates a call with the user 16 of the mobile device 12 (step 504). Again, in this example, the user 16 is also referred to as the recipient 16, and the user 18 is also referred to as the caller 18.

In response, the mobile device 12, and more specifically the profile sharing client 26, requests the user profile of the caller 18 from the profile service 20 (step 506). In response to the request, the profile service 20 identifies the user profile of the caller 18 and determines the access rights granted to the recipient 16 for the user profile of the caller 18 (step 508). Once the access rights of the recipient 16 are determined, the profile service 20 provides the user profile of the caller 18 to the mobile device 12 of the recipient 16 according to the access rights of the recipient 16 (step 510). The user profile of the caller 18 is then presented to the recipient 16 at the mobile device 12 of the recipient 16 (step 512). The recipient 16 then accepts, or answers, the call (step 514), and the call is established (step 516).

In this example, at some point during the call, the profile service 20 identifies one or more other users to recommend adding to the call in order to provide a conference call (step 518). Note, however, if the call is already a conference call between the recipient 16, the caller 18, and one or more additional users, the profile service 20 may recommend additional users for the conference call. The process for recommending other users for the conference call may be automatically performed by the profile service 20 during the call, initiated by a request made by the recipient 16, or the like.

In one embodiment, the profile service 20 selects one or more users from the social network of the recipient 16 as users to recommend adding for the conference call. More specifically, the profile service 20 may first identify a relationship between the recipient 16 and the caller 18 in the social network. The relationship may be defined by a degree of separation; a classifier such as, for example, “friend,” “family,” “co-worker,” or the like; or both degree of separation and a classifier. Then, the profile service 20 may select one or more users from the social network of the recipient 16 having the same relationship with the recipient 16 or a similar relationship with the recipient 16 as users to recommend for the conference call.

In addition or as an alternative to using the relationship of the recipient 16 and the caller 18, the profile service 20 may use a topic of the conversation between the recipient 16 and the caller 18 to select one or more users from the social network of the recipient 16 to recommend for the conference call. The topic of the conversation may be identified by one or both of the mobile devices 12 and 14 using, for example, speech-to-text conversion and then provided to the profile service 20. As another example, the topic of the conversation may be expressly identified by one or both of the users 16 and 18 by entering the topic into a text field or selecting the topic from one or more predefined topics. As a final example, a intermediary device between the mobile devices 12 and 14 in the mobile telecommunications network 22 may infer the topic of the conversation by, for example, using speech-to-text conversion and then provide the topic of the conversation to the profile service 20. Once the topic is identified, the profile service 20 may identify one or more users in the social network of the recipient 16 that have expressed an interest in that topic as users to recommend for the conference call. Note that the users selected to recommend for the conference call may be selected based on a combination of the relationship of the recipient 16 and the caller 18 and the topic of the conversation.

In addition to selecting users to recommend for the conference call from the social network of the recipient 16, the profile service 20 may also select users to recommend for the conference call from the social network of the caller 18. Still further, the profile service 20 may utilize combined user profiles of the recipient 16 and the caller 18 to identify users from the social networks of the recipient 16 and the caller 18. Then, each of the recipient 16 and the caller 18 may individually select users for the conference call. Alternatively, the recipient 16 and the caller 18 may select users for the conference call using a collaborative process such as voting. In order to assist the recipient 16 and the caller 18 in selecting users for the conference call, the profile service 20 may provide information as to why each of the users was recommended for the conference call.

Information identifying the recommended users for the conference call is then sent to the mobile device 12 of the recipient 16 (step 520). The information identifying the recommended users for the conference call may include the user profiles of the recommended users, information from the user profiles of the recommended users such as the names and some or all of the contact information for the recommended users, or the like. The information identifying the recommended users for the conference call is then presented to the recipient 16 (step 522).

In this example, user input is received from the recipient selecting one or more of the recommended users to add to the conference call (step 524). In response, the mobile device 12 establishes or initiates establishment of the conference call (step 526). The conference call includes the recipient 16, the caller 18, and the one or more users selected from the recommended users. In addition, if the recipient 16 and the caller 18 were already on a conference call with one or more other users, the conference call also includes those other users.

It should be noted that while the discussion of FIG. 7 focuses on recommending users for a conference call to the recipient 16, the present invention is not limited thereto. In addition or alternatively, users for a conference call may be recommended to the caller 18. The users recommended to the caller 18 may be selected from the social network of the caller 18 based on the relationship between the caller 18 and the recipient 16 in the social network of the caller 18, a topic of the conversation between the caller 18 and the recipient 16, or both.

Also, while the discussion above focuses on an embodiment where the users recommended for the conference call are selected by the profile service 20, the present invention is not limited thereto. For example, in an alternative embodiment, the recommended users may be selected at the mobile device 12 of the recipient 16 and/or the mobile device 14 of the caller 18. More specifically, with respect to the mobile device 12, the mobile device 12 may obtain information defining the social network of the recipient 16 from the profile service 20 or a social networking service. The mobile device 12 may then select one or more users from the social network of the recipient 16 to recommend for the conference call based on a relationship between the recipient 16 and the caller 18 and/or a topic of the conversation between the recipient 16 and the caller 18. Likewise, users to recommend to the caller 18 for the conference call may be selected by the mobile device 14.

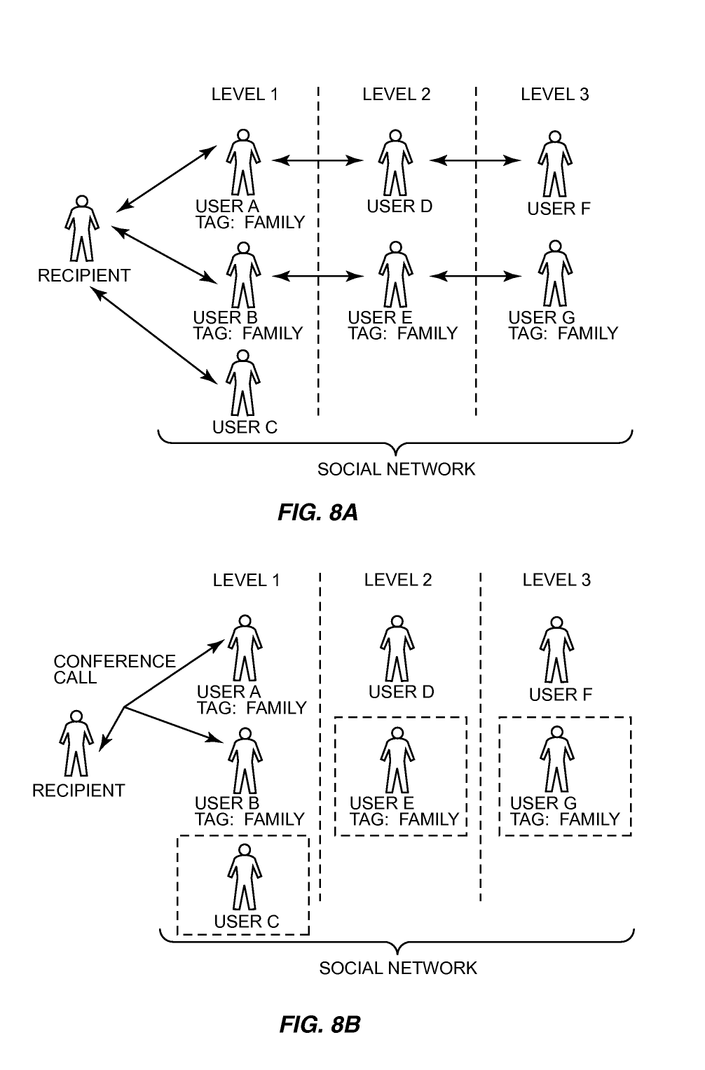

FIGS. 8A and 8B graphically illustrate selection of users from a social network of the recipient 16 to recommend for a conference call according to one embodiment of the present invention. FIG. 8A illustrates a social network of the recipient 16. FIG. 8B illustrates an example where the recipient 16 is currently on a conference call with users A and B. Both user A and user B have a direct relationship with the recipient 16 in the social network of the recipient 16 and are classified as “family.” As such, based on the relationship between the recipient 16 and the users A and B, user C is recommended for adding to the conference call because user C also has a direct relationship with the recipient 16. In addition, users E and G are recommended for the conference call because both user E and user G are classified as “family.”

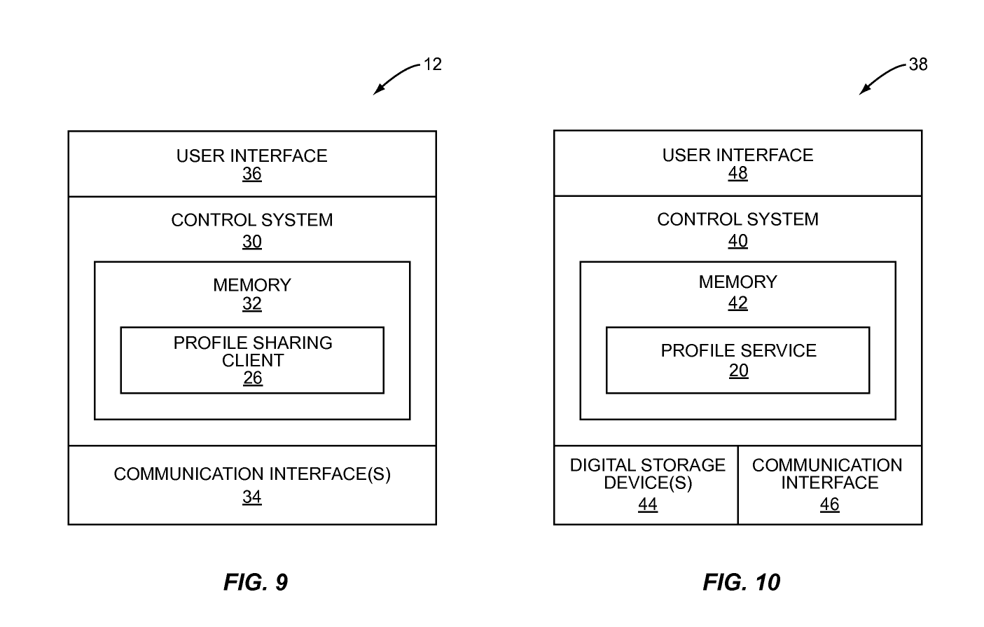

FIG. 9 is a block diagram of the mobile device 12 of FIG. 1 according to one embodiment of the present invention. In general, the mobile device 12 includes a control system 30 having associated memory 32. In this embodiment, the profile sharing client 26 is implemented in software and stored in the memory 32. However, the present invention is not limited thereto. The profile sharing client 26 may be implemented in software, hardware, or a combination thereof. In addition, the mobile device 12 includes one or more communication interfaces 34 communicatively coupling the mobile device 12 to the mobile telecommunications network 22 and the network 24 (FIG. 1). Lastly, the mobile device 12 includes a user interface 36, which includes components such as, for example, a display, a microphone, one or more speakers, one or more user input devices, and the like.

FIG. 10 is a block diagram of a server 38 hosting the profile service 20 of FIG. 1 according to one embodiment of the present invention. In general, the server 38 includes a control system 40 having associated memory 42. In this embodiment, the profile service 20 is implemented in software and stored in the memory 42. However, the present invention is not limited thereto. The profile service 20 may be implemented in software, hardware, or a combination thereof. In addition, the server 38 includes one or more digital storage devices 44, which may be one or more hard-disk drives or the like. In one embodiment, the user profiles of the users 16 and 18 (FIG. 1) as well as user profiles for a number of additional users associated with the system 10 are stored in the one or more digital storage devices 44. In an alternative embodiment, the user profiles may be stored by one or more remote sources such as one or more remote servers hosting one or more social networking services. The server 38 also includes a communication interface 46 communicatively coupling the server 38 to the network 24 (FIG. 1). Lastly, the server 38 may include a user interface 48, which may include components such as, for example, a display, one or more user input devices, or the like.

Those skilled in the art will recognize improvements and modifications to the preferred embodiments of the present invention. All such improvements and modifications are considered within the scope of the concepts disclosed herein and the claims that follow.

What is claimed is:

1. A method of operation of a device of a first user, comprising:
requesting, from a profile service, a user profile of a second user in association with initiation of a communication session between the first and second users via the device of the first user and a device of the second user; and
receiving, from the profile service, the user profile of the second user according to access rights to the user profile of the second user granted to the first user by the second user.

2. The method of claim 1 further comprising presenting the user profile of the second user to the first user according to the access rights granted to the first user.

3. The method of claim 1 wherein the communication session is a voice session.

4. The method of claim 1 wherein requesting the user profile comprises requesting the user profile of the second user in response to initiation of the communication session between the first and second users.

5. The method of claim 1 wherein requesting the user profile comprises requesting the user profile of the second user during the communication session between the first and second users.

6. The method of claim 5 wherein requesting the user profile of the second user during the communication session between the first and second users comprises requesting the user profile of the second user during the communication session between the first and second users in response to a request from the first user.

7. The method of claim 1 wherein requesting the user profile comprises requesting the user profile of the second user in response to establishment of the communication session between the first and second users.

8. The method of claim 1 wherein access rights to the user profile of the second user are defined for each of a plurality of users including the first user.

9. The method of claim 1 wherein access rights to the user profile of the second user are defined for each of a plurality of groups of users including a group of users that includes the first user.

10. The method of claim 1 wherein receiving the user profile of the second user according to the access rights to the user profile of the second user granted to the first user comprises receiving a version of the user profile of the second user that does not include content from the user profile of the second user to which the first user has not been granted access by the second user.

11. The method of claim 1 wherein receiving the user profile of the second user according to the access rights to the user profile of the second user granted to the first user comprises:
receiving an encrypted version of the user profile of the second user from the profile service; and
controlling access to the encrypted version of the user profile at the device according to the access rights granted to the first user using a Digital Rights Management (DRM) technique.

12. The method of claim 1 wherein receiving the user profile of the second user according to the access rights to the user profile of the second user granted to the first user comprises:
receiving an encrypted version of the user profile of the second user from the profile service;
receiving a license enabling access to the encrypted version of the user profile of the second user according to the access rights granted to the first user; and
controlling access to the user profile of the second user at the device based on the license.

13. The method of claim 12 further comprising:
receiving an updated license in response to an update to the access rights granted to the first user provided by the second user; and
controlling access to the encrypted version of the user profile of the second user according to the updated license.

14. The method of claim 12 further comprising, at some time after the communication session between the first and second users has terminated and before a subsequent communication session between the first and second users is initiated:
receiving an updated license in response to an update to the access rights granted to the first user provided by the second user; and
controlling access to the encrypted version of the user profile of the second user according to the updated license.

15. The method of claim 1 wherein further comprising receiving an update to the user profile of the second user in response to the user profile being updated by the second user.

16. The method of claim 1 further comprising, at some time after the communication session between the first and second users has terminated and before a subsequent communication session between the first and second users is initiated, receiving an update to the user profile of the second user in response to the user profile being updated by the second user.

17. The method of claim 1 further comprising:
receiving an update to a copy of the user profile stored by the device of the first user in response to an update to the access rights to the user profile granted to the first user by the second user; and
updating the copy of the user profile stored by the device of the first user in response to the update.

18. The method of claim 1 further comprising, at some time after the communication session between the first and second users has terminated and before a subsequent communication session between the first and second user is initiated:
receiving an update to a copy of the user profile stored by the device of the first user in response to an update to the access rights to the user profile granted to the first user by the second user; and
updating the copy of the user profile stored by the device of the first user in response to the update.

19. The method of claim 1 wherein the user profile of the second user comprises at least one of a group consisting of: contact information for the second user, a picture of the second user, information identifying one or more media items recently played by the second user, information identifying one or more websites recently visited by the second user, information identifying one or more locations recently visited by the second user, information identifying one or more media items recommended by the second user, information identifying one or more websites recommended by the second user, a list of one or more contacts of the second user, information identifying a custom ringtone for the second user, a custom ringtone for the second user, one or more media items shared by the second user, and a reference to one or more media items shared by the second user.

20. The method of claim 1 further comprising:
obtaining information identifying a relationship between the first and second users in a social network; and
presenting the information identifying the relationship between the first and second users in the social network to the first user at the user device of the first user.

21. The method of claim 1 wherein the communication session is initiated by the second user, and the method further comprises:
obtaining information identifying a relationship between the first and second users in a social network; and
notifying the first user of the initiation of the communication session by the second user via an alert selected based on the relationship between the first and second users in the social network.

22. The method of claim 21 wherein a user profile of the first user defines a desired alert for each of a plurality of relationship types, and the method further comprises:
selecting the desired alert for one of the plurality of relationship types corresponding to the relationship between the first and second users in the social network as the alert to be used to notify the first user of the initiation of the communication session by the second user.

23. The method of claim 21 wherein the user profile of the second user defines a desired alert for each of a plurality of relationship types, and the method further comprises:
selecting the desired alert for one of the plurality of relationship types corresponding to the relationship between the first and second users in the social network as the alert to be used to notify the first user of the initiation of the communication session by the second user.

24. The method of claim 21 wherein the information identifying the relationship between the first and second users comprises a degree of separation between the first and second users in the social network.

25. The method of claim 21 wherein the information identifying the relationship between the first and second users comprises a classifier describing the relationship between the first and second users in the social network.

26. The method of claim 1 further comprising:
making a determination as to whether to recommend adding the second user as a contact of the first user in a social network; and
if the determination is made to recommend adding the second user as a contact of the first user in the social network, presenting, to the first user at the device of the first user, a recommendation to add the second user as a contact.

27. The method of claim 26 wherein making the determination comprises making the determination as to whether to recommend adding the second user as a contact of the first user in the social network based on a call log.

28. The method of claim 26 wherein making the determination comprises making the determination as to whether to recommend adding the second user as a contact of the first user in the social network based on limitations defined by the second user as to who can request to add the second user as a contact in the social network.

29. The method of claim 26 further comprising:
receiving a response from the first user indicating that the first user has accepted the recommendation; and
causing the second user to be added as a contact of the first user in the social network in response to receiving the response from the first user.

30. The method of claim 1 further comprising:
making a determination as to whether to recommend removing the second user as a contact of the first user in a social network; and
if the determination is made to recommend removing the second user as a contact of the first user in the social network, providing, to the first user at the device of the first user, a recommendation to remove the second user as a contact.

31. The method of claim 30 wherein making the determination comprises making the determination as to whether to recommend removing the second user as a contact of the first user in the social network based on a call log.

32. The method of claim 30 further comprising:
receiving a response from the first user indicating that the first user has accepted the recommendation; and
causing the second user to be removed as a contact of the first user in the social network in response to receiving the response from the first user.

33. The method of claim 1 wherein the communication session is a call, and the method further comprises:
identifying one or more users from a social network of the first user to recommend for adding to the call to provide a conference call; and
presenting, to the first user, information identifying the one or more users recommended for adding to the call to provide the conference call.

34. The method of claim 33 wherein identifying one or more users from the social network of the first user to recommend for adding to the call to provide the conference call comprises:
identifying a relationship between the first and second users in the social network of the first user; and
selecting one or more other users from the social network of the first user having a relationship with the first user that is substantially the same as the relationship between the first and second users as the one or more users to recommend for adding to the call.

35. The method of claim 33 wherein identifying one or more users from the social network of the first user to recommend for adding to the call to provide the conference call comprises:
identifying a topic of a conversation between the first and second users on the call; and
selecting one or more other users from the social network of the first user having expressed an interest in the topic as the one or more users to recommend for adding to the call.

36. The method of claim 1 wherein the communication session is one of a group consisting of: a call provided via a mobile telecommunications service and a call provided via a Voice Over Internet Protocol (VOIP) service.

37. A device of a first user, comprising:
at least one communication interface; and
a control system associated with the at least one communication interface and adapted to:
request a user profile of a second user from a profile service via the at least one communication interface in association with initiation of a communication session between the first and second users via the device of the first user and a device of the second user; and
receive the user profile of the second user according to access rights to the user profile of the second user granted to the first user by the second user from the profile service via the at least one communication interface.

38. The device of claim 37 wherein the control system is further adapted to present the user profile of the second user to the first user according to the access rights granted to the first user.

39. A computer readable medium comprising software for instructing a device of a first user to:
request, from a profile service, a user profile of a second user in association with initiation of a communication session between the first and second users via the device of the first user and a device of the second user;
receive, from the profile service, the user profile of the second user according to access rights to the user profile of the second user granted to the first user by the second user.

40. The computer readable medium of claim 39 wherein the software is further adapted to instruct the device to present the user profile of the second user to the first user according to the access rights granted to the first user.
